(19) United States
(12) Patent Application Publication
(10) Pub. No.: US 2007/0207444 A1
(43) Pub. Date: Sep. 6, 2007

(54) DENTAL POST AND ITS PRODUCTION METHOD

(75) Inventors: Pierre-Luc Reynaud, Vaulnaveys Le Haut (FR); Manh-Quynh Chu, Fontanil Cornillon (FR); Frederic Sanchette, Montferrat (FR); Laurent Bedel, Quaix en Chartreuse (FR)

Correspondence Address: HESLIN ROTHENBERG FARLEY & MESITI PC, 5 COLUMBIA CIRCLE, ALBANY, NY, 12203, US

(73) Assignee: Recherches Et Techniques Dentaires - R.T.D., Saint Egreve (FR)

(21) Appl. No.: 11/680,826

(22) Filed: Mar. 1, 2007

(30) Foreign Application Priority Data
Mar. 2, 2006 (FR) 0650732

(51) Int. Cl. A61C 5/08

(52) U.S. Cl. 433/220

(57) ABSTRACT

Dental post made of a composite material contains a central core constituted of a resin matrix in which fibres are embedded. The core is surrounded by a sheath. The sheath is free of fibres and contains at least one substance which can make the post radiopaque.

The invention concerns a new dental post, which may be radiopaque, with improved composite cement adhesion properties. It also concerns a production method for said post.

Dental posts are used for the reconstitution of pulpless teeth. A distinction is made between two types of posts, metal or ceramic posts and composite posts, respectively.

Metal posts are usually made of stainless steel. Their main disadvantage is that they are subject to corrosion phenomena. Moreover, they have a transversal modulus of elasticity that is different from that of the dentine, leading to post separation over time

To solve these problems, posts made of composite materials have been proposed, notably such as those described in document EP-A-432 001. In practice, these posts are constituted of long fibres made of glass or carbon, and more generally any material with strong mechanical characteristics, said fibres being embedded in a thermosetting resin matrix, notably by pultrusion techniques. In general, the proportion of long fibres accounts for 50 to 70% of the volume of the post, the complement to 100% being occupied by the matrix. The disadvantage of these posts, however, is that they are not radiopaque.

It is necessary for the surgeon to be able to view the post when inserting it or during a postoperative intervention, by X-ray radiography. Several solutions have been proposed to make composite materials radiopaque. One of them consists in adding radiopaque metal oxides to the resin matrix and/or the reinforcement fibres. This technique is described, for example, in document EP-A-793 474. Generally, the proportion of metal oxide in the matrix can be up to 50% by weight, while it is approximately 10 to 30% in the fibres, depending on the nature of the metal oxide used. Such a solution is not optimal in terms of mechanical properties and radiographic intensity. Indeed, when added to the matrix, metal oxides tend to form agglomerates, which leads to disruption of the cohesion between the fibres and the resin matrix. Mechanical performances are then lost. As an example, the three-point flexural strength of a section without metal oxide and containing 64% by volume of unidirectional quartz fibres is approximately 1600-1800 MPa. The same section, containing 40% by weight of metal oxide in the matrix, i.e. 10% by weight of the material, has a flexural strength of 1100 MPa. Such mechanical performances are therefore incompatible with the use of small-diameter posts or those with retention on their surface.

Another disadvantage lies in the transparency of the posts, since this transparency is affected by the presence of metal oxides. This leads to a decrease in the transmission of light beams from the lamp used to cure the adhesive.

Moreover, the radiopacity obtained turns out to be insufficient given the low metal oxide content. While certainly the level of radiopacity is increased by adding metal oxides both in the matrix and in the fibres, this is not without influence on the mechanical properties of the post.

Document WO 96/26686 proposes sheathing a non-radiopaque composite post with a radiopaque sheath, the sheath being constituted of at least one, and advantageously two, coats of radiopaque fibres, such as glass fibres containing calcium oxide. While this solution makes it possible to view the contours of the post and improves mechanical characteristics due to the presence of fibres, the level of radiopacity is still insufficient because of weak radiographic density. Moreover, applying the sheath through pultrusion is a delicate operation and obtaining a regular coat is particularly difficult.

Furthermore, and in a known way, the composite posts are glued and sealed into the roots when they are inserted by the dental surgeon, using composite cement. Now, it has been observed that this gluing is particularly difficult to do, given the nature of the composite material. To solve this problem, the dental surgeon is required to apply an adhesion primer or a coat of silane extemporaneously to the post surface before gluing, in order to improve the bond with the composite cement. Such a step is a constraint for the surgeon. Moreover, we can see that the silanisation performed on the posts is not satisfactory in that it does not provide optimum adhesion of the composite cement.

In other terms, the problem that the invention is designed to solve is that of developing a post made of a composite material which may be radiopaque, but without affecting its mechanical characteristics and its transparency, and whose capacity for adhesion to composite cements is improved.

To do this, the Applicant has observed that, rather than using a radiopaque fibre-based sheath, implementing a radiopaque substance-based coating would concomitantly solve the aforementioned problems. Notably concerning the improvement to adhesion capacity, the Applicant has hypothesised that the presence of a non-organic sheath around the post creates bonds with the silane throughout the post surface, which is not the case of posts in the previous art in which the bond was only formed on the part of the surface where the non-organic reinforcement fibres are located. The presence of silane distributed homogeneously and regularly throughout the surface of the post thus makes it possible to create a junction between the composite cement and the post.

In other words, the subject of the invention is a dental post made of a composite material containing a central core constituted of a resin matrix in which fibres are embedded, said core being surrounded by a sheath. This post is characterised in that the sheath is free of fibres and contains at least one substance which can make said post radiopaque, said substance also making it possible to improve adhesion to composite cement after silanisation.

Of course, radiographic intensity will depend on the quantity of substance applied to the surface of the post. In practice, said substance providing radiopacity and improving adhesion to composite cement after silanisation accounts for 0.5% to 30% by weight of the post.

The substance may be applied in one or more coats, advantageously in a single coat, using the technique called “PVD” (Physical Vapour Deposition), the “EBPVD” technique (Electron Beam Physical Vapour Deposition) or the “CVD” technique (Chemical Vapour Deposition), or else using the magnetron technique (magnetron cathode sputtering).

The sheath may contain a variable proportion of said substance which may be between 5 and 100% by weight, advantageously at least 90% by weight, the complement to 100% being constituted by impurities whose presence is related to the process of applying the coating, notably by PVD. The thickness of said sheath will depend on the desired level of radiopacity. In practice, the thickness of the sheath is between 0.1 and 60 μm, advantageously between 0.5 and 30 μm. Throughout the range, there is a possibility of performing regular silanisation to improve composite cement adhesion, although the objective remains having the smallest possible sheath thickness.

Among the substances which could provide radiopacity, certain metal oxides, certain fluorinated compounds and carbonates can be used.

Among the metal oxides, we can notably mention aluminium oxide (Al₂O₃), barium oxide (BaO), strontium oxide (SrO), tungsten oxide (WO₃), zinc oxide (ZnO) and zirconium oxide (ZrO).

Among the fluorinated compounds, we can notably mention ytterbium (YbF₃) and yttrium (YF3).

Among the carbonates, we can notably mention lanthanum carbonate (La₂(CO₃)₃) or zirconium carbonate (ZrCO₃).

Of course, all of these substances may be used alone or in mixtures.

In a preferred embodiment, the post is covered with a sheath made of metal oxide, advantageously zirconium oxide, the sheath having a thickness between 0.2 and 2 μm, advantageously approximately 1 μm.

To further improve radiopacity, one or more substances which can provide radiopacity may also be added to the matrix and/or fibres, while taking into account the technical constraints mentioned above. Notably, the fibres that can be used are AR fibres containing 18-19% zirconia by weight. In this case, the fibres account for 50 to 70% of the post by weight, whereas the matrix accounts for 30 to 50% of the post by weight, excluding the sheath.

According to another characteristic, the silanisation step used to improve the gluing of the post into the root can be performed at the time of production or later, by the dental surgeon, when inserting the post.

In a particular embodiment, the sheath therefore also contains at least one silane. In practice, the silanes are chosen from the group including 3-(trimethoxysilyl)propyl methacrylate, vinyltrimethoxysilane, 3-(glycidyloxy)propyl trimethoxysilane and 3-(trimethoxysilyl)propyl methacrylate.

The invention also concerns a method for producing the aforementioned post.

According to this process:
a post is produced using a composite material, containing a central core made of fibres embedded in a resin matrix,
at least one coat is deposited on the surface of said post, containing at least one substance which can make the post radiopaque.

The post is produced using any technique known to those skilled in the art, notably using a pultrusion technique followed by machining of the rod obtained.

According to another aspect, the coat of radiopaque substance is deposited, as already said, by PVD, EBPVD, Magnetron (magnetron cathode sputtering) or CVD.

In a particular embodiment, the post of the invention is silanised after applying the radiopaque substance.

In practice, the silane is deposited by soaking the post in a silane solution. This soaking can be performed at the time of production of the post or extemporaneously by the surgeon.

The invention and the resulting advantages will be made clear by the following examples of embodiments.

### EXAMPLE 1

The posts are made of E-glass fibres accounting for a volume of 63%. The fibres are embedded in a methacrylic resin matrix with a BISGMA monomer base (Bisphenol A Glycidyl Dimethacrylate), 1,4 Butanediol Dimethacrylate and 1,6 Hexanediol Dimethacrylate HDDMA. The matrix accounts for 37% by volume and does not contain any radiopaque filler. The diameter of the posts is 1.8 mm.

1^{st} Step: Deposition of a Coating Containing Zirconium Oxide on the Surface of Dental Posts

The posts are inserted into a metal support, the tip upward. Zirconium oxide-based deposits are produced using the EBPVD technique (Electron Beam Physical Vapour Deposition) from an yttrium-stabilised zirconium oxide source (ZrO₂—Y₂O₃ 8% molar). The posts attached to a metal support are positioned 29 cm above the evaporation source. Before deposition, a 4.10⁻³ Pa vacuum is formed in the reactor. A 4-sccm flow of oxygen is introduced during the deposition step. Source evaporation by electron beam is performed with an 8.6 kV power in a 10⁻¹ Pa vacuum.

The zirconium oxide coating covers the entire surface of the posts, except for a 2- to 3-mm length which the practitioner will cut off when putting it in place. The thickness of the deposit obtained is approximately 30 μm on average and it has no influence on the size characteristics of the post since the thickness of the coating is taken into account when machining the posts.

Such thickness provides radiographic intensity equivalent to 1.3 mm aluminium.

2^{nd} Step: Silanisation

Preparation of the solution

Ethanol solution containing approximately 10% acetic acid acidified water

MEMO: 3-(trimethoxysilyl)propyl methacrylate 5% by weight

Mix for at least 30 minutes

The posts are then soaked in this solution containing silane MEMO for 15 minutes. They are dried in a drier to evaporate the solvent and water. The silane thus deposited forms a chemical bond between the outer coating of the post and the composite cement. Free elements such as OH groups will create chemical bridging between the adhesive and the post through its outer coating.

The gluing results obtained with the posts produced according to this example were improved: 32 MPa rather than 26.9 MPa with an adhesive and 32 MPa rather than 23 MPa without adhesive.

Moreover, the gluing or sealing protocol was reduced by one step. Indeed, it is no longer necessary to apply an adhesive coating to the post and then to light cure it.

### EXAMPLE 2

The posts are made of AR glass fibres accounting for a volume of 60%. The fibres are embedded in an epoxide resin matrix with a Bisphenol A base. The matrix accounts for 40% by volume and does not contain any radiopaque filler.

The diameter of the posts is 1.8 mm.

1^{st} Step: Deposition of a Coating Containing Zirconium Oxide on the Surface of Dental Posts.

The posts are treated under operating conditions identical to those described in the previous example.

The zirconium oxide coating covers the entire surface of the posts, except for a 2- to 3-mm length which the practitioner will cut off when putting it in place. The thickness of the deposit obtained is approximately 2 μm on average and it has no influence on the size characteristics of the post. The space for gluing and sealing is at least 20 μm on the radius.

The gluing results obtained with the posts produced according to this example were improved: 33.7 MPa rather than 26.9 MPa with an adhesive and 33.7 MPa rather than 23 MPa without adhesive. The gluing or sealing protocol was reduced by one step.

It should be pointed out that the gluing value on identical posts without the zirconium oxide coating, but with silane MEMO alone, is 29 MPa±5 MPa. While this zirconium oxide coating is of low thickness, it gives adhesion values that are more stable and constant (33.7 MPa±3 MPa with the zirconium oxide coating).

### EXAMPLE 3

The posts are made of E-glass fibres accounting for a volume of 57%. The fibres are embedded in an epoxide resin matrix with a Bisphenol A base.

The matrix accounts for 43% by volume and contains radiopaque fillers in the form of strontium and zirconium glass particles with an average diameter of 1 μm in a proportion of 30% by weight in relation to the matrix.

The diameter of the posts is 1.8 mm and they have a coating of alumina and zirconia on their surface.

The zirconia or alumina is deposited using the so-called CVD technique (Chemical Vapour Deposition). In this case, a zirconate solution, for example tetrapropyl zirconate or zirconium propoxide at 70% in propanol is injected as a precursor into the plasma gas. The zirconium oxide condenses on the posts.

After zirconium oxide deposition by CVD (plasma), the posts are subjected to a treatment cycle to activate the surface and to remove any traces of other undesirable elements. This treatment is done using a H₂/N₂ mixture. After zirconium oxide deposition by CVD, the posts are silanised as in the previous examples.

The gluing results obtained with the posts produced according to this example were improved: 33.5 MPa rather than 26.9 MPa with an adhesive and 33.5 MPa rather than 23 MPa without adhesive. The gluing or sealing protocol was reduced by one step. The standard deviation obtained was 33.5 Mpa±3 MPa.

1/ Dental post made of a composite material containing a central core constituted of a resin matrix in which fibres are embedded, said core being surrounded by a sheath, wherein the sheath is free of fibres and contains at least one substance which can make the post radiopaque.

2/ Post as claimed in claim 1, wherein the at least one substance which can make the post radiopaque accounts for 0.5% to 30% of the post by weight.

3/ Post as claimed in claim 1, wherein the sheath contains 5 to 100% of said at least one substance by weight.

4/ Post as claimed in claim 1, wherein thickness of the sheath is between 0.1 μm and 60 μm.

5/ Post as claimed in claim 1, wherein said at least one substance is selected from the group consisting of aluminium oxide, barium oxide, strontium oxide, tungsten oxide, zinc oxide, zirconium oxide, ytterbium, yttrium, lanthanum carbonate and zirconium carbonate.

6/ Post as claimed in claim 1, wherein the sheath also contains at least one silane.

7/ Post as claimed in claim 6, wherein the silane is selected from the group consisting of 3-(trimethoxysilyl)propyl methacrylate, vinyltrimethoxysilane, 3-(glycidyloxy)propyl trimethoxysilane and 3-(trimethoxysilyl)propyl methacrylate.

8/ Post as claimed in claim 1, wherein the fibres are radiopaque fibres.

9/ Post as claimed in claim 1, wherein the matrix also contains at least one substance that can provide radiopacity.

10/ Method for producing a dental post made of a composite material, wherein:
a post is produced containing fibres embedded in a resin matrix,
at least one coat containing at least one substance which can make the post radiopaque is applied to a surface of the post.

11/ Method as claimed in claim 10, wherein said substance is applied to the surface using a vapour-phase deposition technique, EBPVD or a magnetron technique.

12/ Method as claimed in claim 10, wherein said substance is selected from the group consisting of aluminium oxide, barium oxide, strontium oxide, tungsten oxide, zinc oxide, zirconium oxide, ytterbium, yttrium, lanthanum carbonate and zirconium carbonate.

13/ Method as claimed in claim 10, wherein once the coat containing at least one substance which can make the post radiopaque has been applied, the post is silanised.

14/ Post as claimed in claim 4, wherein the thickness of the sheath is between 0.5 μm and 30 μm.

15/ Post as claimed in claim 8, wherein the radiopaque fibres comprise AR glass fibres.
